(19) United States
(12) Patent Application Publication
(10) Pub. No.: US 2015/0331844 A1
(43) Pub. Date: Nov. 19, 2015

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Tomonari TAKAHASHI, Yokohama-shi (JP)

(21) Appl. No.: 14/520,623

(22) Filed: Oct. 22, 2014

(30) Foreign Application Priority Data
May 15, 2014 (JP) 2014-101147

(51) Int. Cl. G06F 17/24

(52) U.S. Cl. CPC G06F 17/246

(57) ABSTRACT

An information processing apparatus includes a detection unit, a combining unit, and a definition unit. The detection unit detects a character acceptance frame from a spreadsheet having the character acceptance frame. The combining unit combines cells in the spreadsheet into a combined cell, the cells corresponding to the character acceptance frame detected by the detection unit. The definition unit defines the combined cell generated by the combining unit as one cell that accepts a character string to be written in the character acceptance frame.

### CROSS-REFERENCE TO RELATED APPLICATIONS

This application is based on and claims priority under 35 USC 119 from Japanese Patent Application No. 2014-101147 filed May 15, 2014.

### BACKGROUND

1. Technical Field

The present invention relates to an information processing apparatus and a non-transitory computer readable medium.

2. Summary

According to an aspect of the invention, there is provided an information processing apparatus including a detection unit, a combining unit, and a definition unit. The detection unit detects a character acceptance frame from a spreadsheet having the character acceptance frame. The combining unit combines cells in the spreadsheet into a combined cell, the cells corresponding to the character acceptance frame detected by the detection unit. The definition unit defines the combined cell generated by the combining unit as one cell that accepts a character string to be written in the character acceptance frame.

### BRIEF DESCRIPTION OF THE DRAWINGS

An exemplary embodiment of the present invention will be described in detail based on the following figures, wherein:

FIG. 1 is a conceptual module configuration diagram illustrating an example configuration according to the exemplary embodiment;

FIG. 2 is a conceptual module configuration diagram illustrating an example configuration according to the exemplary embodiment;

FIG. 3 is an explanatory diagram illustrating an example of a system configuration that implements the exemplary embodiment;

FIG. 4 is an explanatory diagram illustrating an example of a target spreadsheet;

FIG. 5 is an explanatory diagram illustrating an example of a process according to the exemplary embodiment;

FIG. 6 is an explanatory diagram illustrating an example of a process according to the exemplary embodiment;

FIGS. 7A and 7B are explanatory diagrams illustrating an example of a process according to the exemplary embodiment;

FIGS. 8A and 8B are explanatory diagrams illustrating an example of a process according to the exemplary embodiment;

FIGS. 9A and 9B are explanatory diagrams illustrating an example of a process according to the exemplary embodiment;

FIGS. 10A and 10B are explanatory diagrams illustrating an example of a process according to the exemplary embodiment;

FIG. 11 is an explanatory diagram illustrating an example of a process according to the exemplary embodiment;

FIG. 12 is a flowchart illustrating an example of a process according to the exemplary embodiment;

FIG. 13 is a flowchart illustrating an example of a process according to the exemplary embodiment;

FIGS. 14A and 14B are explanatory diagrams illustrating an example of a process according to the exemplary embodiment;

FIGS. 15A and 15B are explanatory diagrams illustrating an example of a process according to the exemplary embodiment;

FIG. 16 is an explanatory diagram illustrating an example of the data structure of a correspondence table;

FIGS. 17A and 17B are explanatory diagrams illustrating an example of a process according to the exemplary embodiment;

FIGS. 18A and 18B are explanatory diagrams illustrating an example of a process according to the exemplary embodiment; and

FIG. 19 is a block diagram illustrating an example of the hardware configuration of a computer that implements the exemplary embodiment.

### DETAILED DESCRIPTION

Hereinafter, an exemplary embodiment of the present invention will be described with reference to the attached drawings.

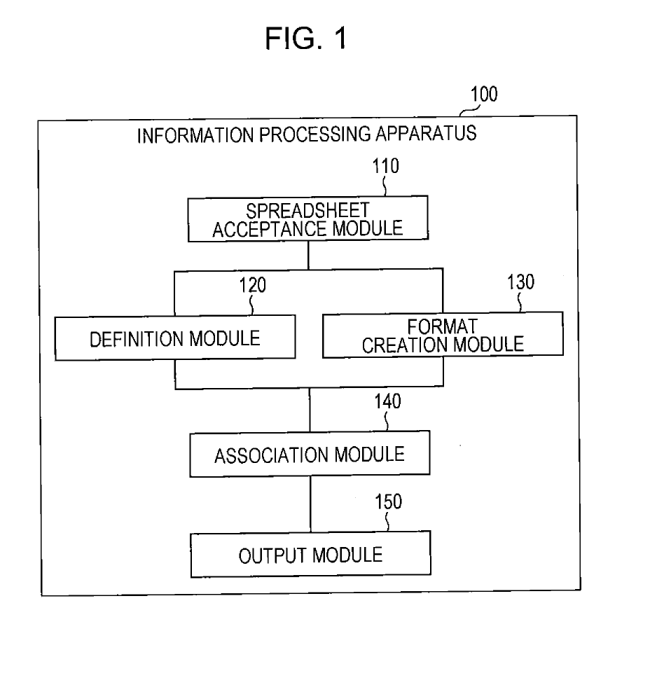

FIG. 1 is a conceptual module configuration diagram illustrating an example configuration according to the exemplary embodiment.

Modules are components of software (computer program) or hardware that may be generally and logically separated from one another. Thus, the modules according to the exemplary embodiment correspond to not only modules in a computer program but also modules in a hardware configuration. Therefore, the description of the exemplary embodiment includes a description of a computer program for causing a computer to function as those modules (a program for causing a computer to execute individual program steps, a program for causing a computer to function as individual units, or a program for causing a computer to implement individual functions), a system, and a method. For the convenience of description, expressions “store”, “cause . . . to store”, and expressions equivalent thereto will be used. These expressions specifically mean “cause a storage device to store” or “perform control to cause a storage device to store” in the case of a computer program. The modules may correspond to functions in a one-to-one relationship. In terms of packaging, a single module may be constituted by a single program, plural modules may be constituted by a single program, or a single module may be constituted by plural programs. Also, plural modules may be executed by a single computer, or a single module may be executed by plural computers in a distributed or parallel environment. Alternatively, a single module may include another module. Hereinafter, “connection” is used to refer to a logical connection as well as a physical connection (transmission and reception of data, an instruction, a reference relationship between pieces of data, etc.). “Predetermined” means being determined before a certain operation, and includes the meaning of being determined in accordance with a present situation/state or in accordance with a previous situation/state before a certain operation after processing according to the exemplary embodiment starts, as well as before processing according to the exemplary embodiment starts. In a case where there are plural predetermined values, the plural predetermined values may be different from one another, or two or more of the values (of course including all the values) may be the same. A description having the meaning “in the case of A, B is performed” is used as the meaning “whether A or not is determined, and B is performed if it is determined A”, except for a case where determination of whether A or not is unnecessary.

A system or apparatus may be constituted by plural computers, hardware units, devices, or the like connected to one another via a communication medium, such as a network (including communication connections having a one-to-one correspondence), or may be constituted by a single computer, hardware unit, device, or the like. “Apparatus” and “system” are used synonymously. Of course, “system” does not include a man-made social “organization” (social system).

Target information is read from a storage device in individual processing operations performed by respective modules or in individual processing operations performed by a single module. After each processing operation has been performed, the processing result thereof is written into the storage device. Thus, a description of reading from the storage device before a processing operation and writing into the storage device after a processing operation may be omitted. Here, examples of the storage device include a hard disk, a random access memory (RAM), an external storage medium, a storage device connected through a communication line, a register in a central processing unit (CPU), and the like.

An information processing apparatus 100 according to the exemplary embodiment defines a document format for a spreadsheet, and includes, as illustrated in FIG. 1, a spreadsheet acceptance module 110, a definition module 120, a format creation module 130, an association module 140, and an output module 150.

The information processing apparatus 100 according to the exemplary embodiment may be constituted by the spreadsheet acceptance module 110 and the definition module 120. In this case, the information processing apparatus 100 defines a character acceptance frame in a spreadsheet as a cell.

The spreadsheet acceptance module 110 is connected to the definition module 120 and the format creation module 130. The spreadsheet acceptance module 110 accepts a spreadsheet having a character acceptance frame. Here, the spreadsheet is a table that is created using spreadsheet software and that is constituted by rows and columns. The term “spreadsheet” is also used for a set of several tables or spreadsheet software. For example, a spreadsheet is used for calculating or accumulating characters or numerals in a matrix, and for generating a document format by drawing ruled lines. An example of a document format is a form format or the like including at least character acceptance frames, specifically including a table constituted by a set of the character acceptance frames. Hereinafter, a description will be given of a form format as an example.

Character acceptance frames are frames provided on a spreadsheet, and are frames in which a character string is to be input. Character acceptance frames may correspond to unit cells of the spreadsheet in a one-to-one relationship, or a set of plural unit cells may constitute one character acceptance frame. A character acceptance frame may be set as a ruled line (outer frame) in the format setting of cells of the spreadsheet, or may be a drawn rectangle figure or an underline. The shape of a character acceptance frame is rectangular, but the shape that is visually perceived is not necessarily rectangular. The character acceptance frame may have any shape, for example, may be an underline on which a character string is to be written.

Acceptance includes, for example, acceptance of a spreadsheet from another information processing apparatus, and readout of a spreadsheet stored in a hard disk (built in a computer or connected via a communication line). The number of spreadsheets to be accepted may be one, or two or more. The content of a spreadsheet may be a form used for business, a check sheet, or the like.

The definition module 120 is connected to the spreadsheet acceptance module 110 and the association module 140. The definition module 120 defines a data acceptance cell. Specifically, the definition module 120 detects a character acceptance frame from a spreadsheet having the character acceptance frame. Also, the definition module 120 combines cells in the spreadsheet corresponding to the detected character acceptance frame, and defines the cell obtained through the combining as one cell (one data acceptance cell) that accepts a character string to be written in the character acceptance frame. The number of cells to be combined together may be one or more. Combining of one cell results in an original cell. In the case of performing such a combining process, a character acceptance frame is detected in accordance with a change in attribute of sequential cells. The cells to be combined together may be identified, for example, based on the positions of ruled lines or the attribute of the cells. Specifically, scanning is performed in a predetermined scanning direction, and a cell which has a ruled line on the lower side (a ruled line on the lower side of a character acceptance frame) and which does not have a value is determined to be a scanning start cell. First scanning is performed in a predetermined direction starting from the scanning start cell until a cell of a different attribute is found, and the cells that have been subjected to the first scanning are combined together. Subsequently, second scanning is performed in a direction different from the first scanning direction (for example, the direction orthogonal to the first scanning direction) until a cell of a different attribute is found, and the cells that have been subjected to the second scanning are combined together. Here, combining of cells means combining of plural adjacent cells into one cell. The cell obtained through the combining serves as a cell that accepts a character string to be written in a character acceptance frame.

Here, “change in attribute of sequential cells” is applied to cells that are in contact with one another in their one or more sides, and means that there is a difference in attribute among the cells. The attribute of a cell varies, for example, (1) a cell with ruled lines on the left and lower sides (a cell with no value), (2) a cell with a ruled line on the lower side (a cell with no value), (3) a cell with a ruled line on the lower side (a cell with a value), and (4) a cell with no ruled lines on four sides (a cell with no value). As described above, the cells to be combined together may be extracted in accordance with these variations. The attributes of cells may be limited to the above-described four types. Also, a cell with a ruled line on the upper side, a cell with a ruled line on the right side, and the like may be included in addition to the four types of cells.

Writing of a character string may be acceptance of a character code using a keyboard or the like. In this case, an operator is able to generate a cell corresponding to a character acceptance frame without combining cells, only by writing the character acceptance frame. Alternatively, writing of a character string may be, as will be described below, acceptance of a character code as a result of recognition of a character string written by hand on a form that has been obtained by printing a form format on paper.

With the process performed by the definition module 120, a character acceptance frame drawn on a spreadsheet and a cell (combined cell) correspond to each other in a one-to-one relationship.

The definition module 120 may exclude a combined cell in a case where the combined cell has a width, height, or size that is smaller than or equal to a predetermined threshold. This process is performed to exclude a cell that is not suitable for accepting a character string.

The format creation module 130 is connected to the spreadsheet acceptance module 110 and the association module 140. The format creation module 130 creates, using a spreadsheet accepted by the spreadsheet acceptance module 110, a form format in which the position of a character acceptance frame is defined. The character acceptance frame in the form format may be an input region in which handwriting is to be performed. The form format may have a general definition for recognizing hand-written characters, for example, may define a character recognition region, a character recognition condition (language, dictionary, type of characters, etc.), and so forth. As a definition method, definition using information about a data acceptance cell (position, size, setting, etc.) defined on a spreadsheet, definition using elements on a form image (ruled lines, characters, etc.), and a general method for creating a form format from electronic data may be used.

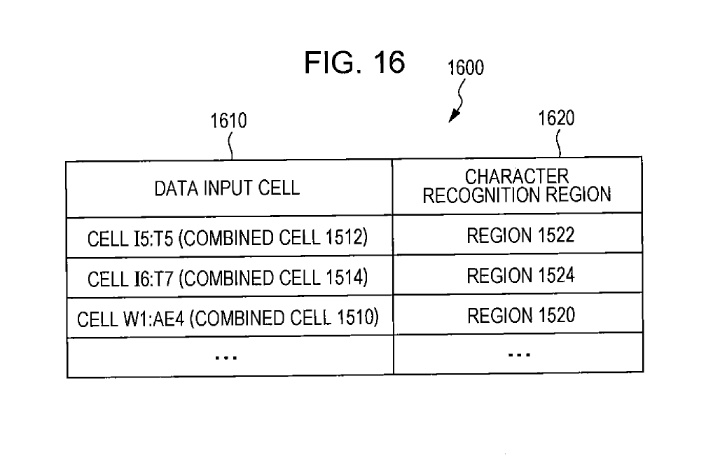

The association module 140 is connected to the definition module 120, the format creation module 130, and the output module 150. The association module 140 associates a cell defined by the definition module 120 with a character acceptance frame in a form format created by the format creation module 130. In a case where the character acceptance frame is used as a frame in which characters are to be written by hand, the association module 140 associates a data acceptance cell with a character recognition region. The result of associating the data acceptance cell with the character recognition region will be described below with reference to FIG. 16.

The output module 150 is connected to the association module 140. The output module 150 outputs a form format for which an association process has been performed by the association module 140. Outputting of the form format may be storing of the form format in a hard disk or the like, transmitting of the form format to another information processing apparatus, or printing of the form format using a printing apparatus such as a printer. In the case of printing the form format, an information image embedded with coordinate information indicating a position in the printed form format may be printed so that online character recognition may be performed.

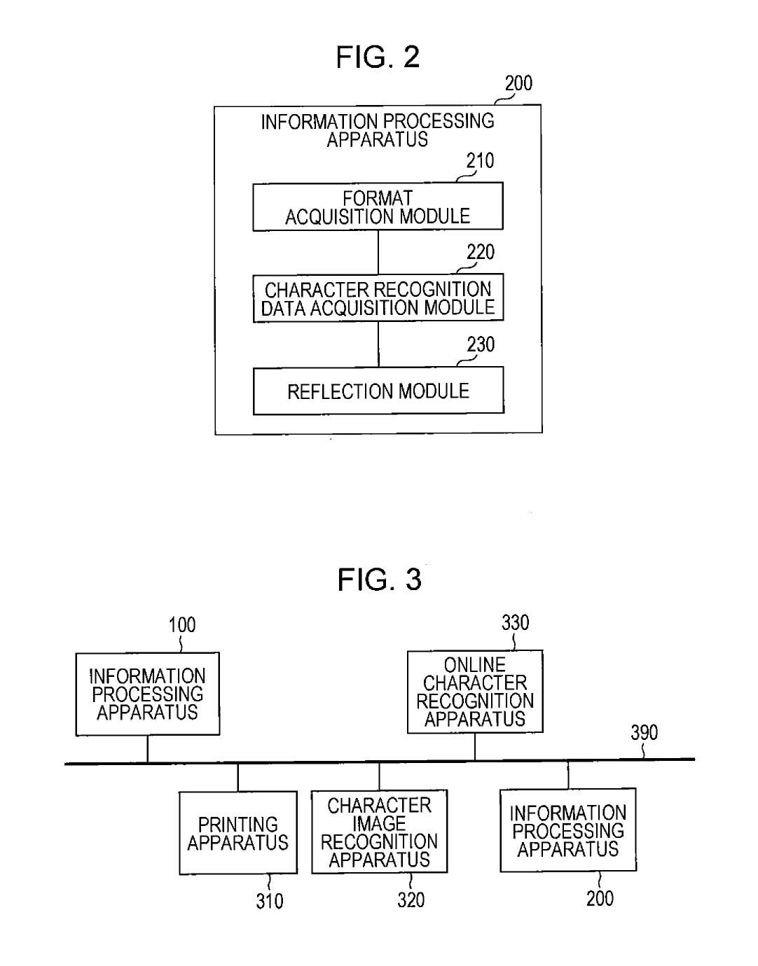

An information processing apparatus 200 according to the exemplary embodiment performs a process of reflecting a character recognition result in a data acceptance cell by using an association result obtained from the information processing apparatus 100, and includes a format acquisition module 210, a character recognition data acquisition module 220, and a reflection module 230 as illustrated in FIG. 2.

The format acquisition module 210 is connected to the character recognition data acquisition module 220. The format acquisition module 210 acquires a form format created by the information processing apparatus 100. A character acceptance frame in the form format is an input region in which handwriting is to be performed. The acquired form format includes the association result generated by the association module 140.

The character recognition data acquisition module 220 is connected to the format acquisition module 210 and the reflection module 230. The character recognition data acquisition module 220 accepts a recognition result of a character string written in a character acceptance frame.

The reflection module 230 is connected to the character recognition data acquisition module 220. The reflection module 230 reflects the recognition result accepted by the character recognition data acquisition module 220 in the cell (data acceptance cell) associated with a character acceptance frame in the form format accepted by the format acquisition module 210. The character recognition result is embedded in a spreadsheet, which is a form format, and a spreadsheet operation may be performed using the spreadsheet.

FIG. 3 is an explanatory diagram illustrating an example of a system configuration according to the exemplary embodiment.

The information processing apparatus 100, the information processing apparatus 200, a printing apparatus 310, a character image recognition apparatus 320, and an online character recognition apparatus 330 are connected to one another via a communication line 390. The communication line 390 may be a wireless link, a wired link, or a combination of both. For example, the communication line 390 may be the Internet, an intranet, or the like serving as a communication infrastructure. Either of the character image recognition apparatus 320 and the online character recognition apparatus 330 may be omitted, or both the apparatuses may be used in a combined manner.

The information processing apparatus 100 transmits a form format including an association result generated by the association module 140 to the information processing apparatus 200 and the printing apparatus 310.

The printing apparatus 310 is a so-called printer, and prints a form format created by the information processing apparatus 100. That is, the printing apparatus 310 prints a form format on which blank character acceptance frames are provided. The printing apparatus 310 may further print an information image embedded with coordinate information indicating a position on the form format so that online character recognition may be performed, as described above.

The character image recognition apparatus 320 reads, as an image, a form (paper) which has been printed by the printing apparatus 310 and on which a character string has been written by hand, and recognizes the hand-written characters. The character image recognition apparatus 320 then transmits a character recognition result to the information processing apparatus 200. This is realized using, for example, a form read by a scanner and an existing optical character recognition (OCR) technique.

The online character recognition apparatus 330 performs online character recognition using strokes of an electronic pen with which handwriting is performed on the form (paper on which an information image has been printed) printed by the printing apparatus 310. The online character recognition apparatus 330 then transmits a character recognition result to the information processing apparatus 200.

The information processing apparatus 200 accepts, from the information processing apparatus 100, the form format including an association result generated by the association module 140, accepts a character recognition result corresponding to the form format from the character image recognition apparatus 320 or the online character recognition apparatus 330, and reflects the character recognition result in the form format.

Next, the processes performed by the individual modules included in the information processing apparatus 100 will be described.

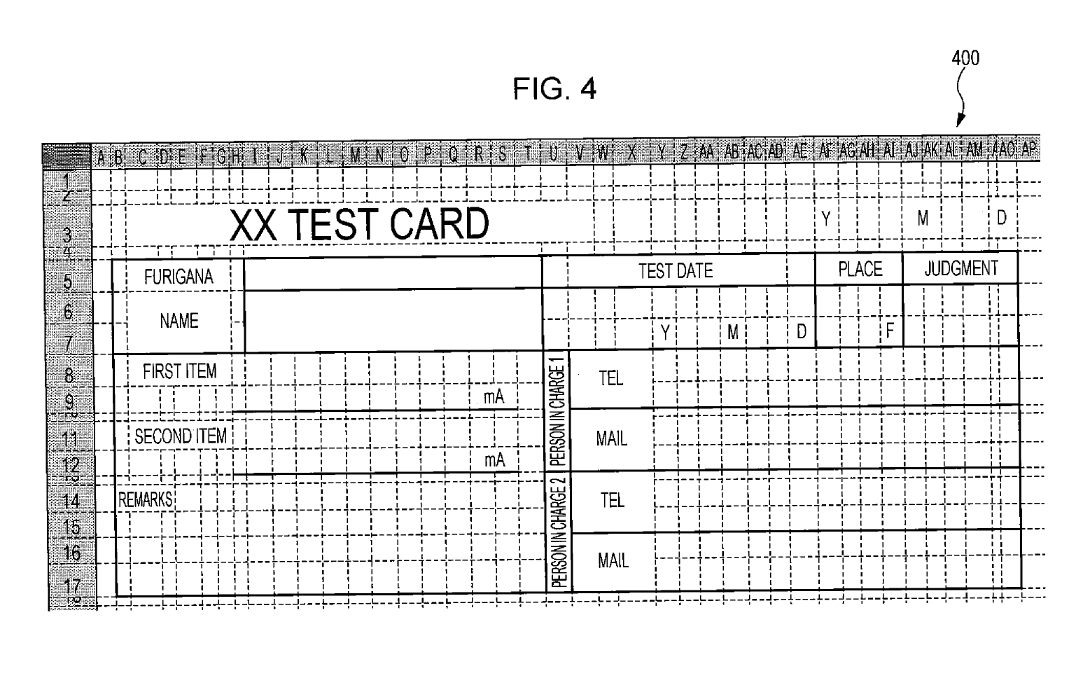

The spreadsheet acceptance module 110 accepts a spreadsheet, which serves as original data of a form format for handwriting. It is assumed that the spreadsheet acceptance module 110 accepts a spreadsheet 400 illustrated in FIG. 4. The spreadsheet 400 is created using spreadsheet software (for example, Excel (registered trademark), Numbers (registered trademark), or the like).

The definition module 120 defines a data acceptance cell using structure information about the spreadsheet 400. Here, terms are defined as follows.

A “unit cell” is one cell in an initial state, serving as the most basic unit in a spreadsheet.

A “cell range” is a set of (unit/combined) cells adjacent to one another. The cell range corresponds to a region that may be surrounded with one stroke before the cells are combined together, and the shape thereof is rectangular, for example.

A “combined cell” is one cell obtained by combining cells in a cell range.

“One cell” is one unit cell or one combined cell that is counted as one on a spreadsheet.

A “data acceptance cell” is one cell that is uniquely defined as a data acceptance region.

The definition module 120 defines a data acceptance cell under the following conditions, for example.

(Condition 1) One cell which does not have a value and is surrounded on four sides by ruled lines is defined as a data acceptance cell.

(Condition 2) A combined cell which does not include a cell with a value and which is obtained by combining cells in a cell range surrounded on four sides by ruled lines is defined as a data acceptance cell.

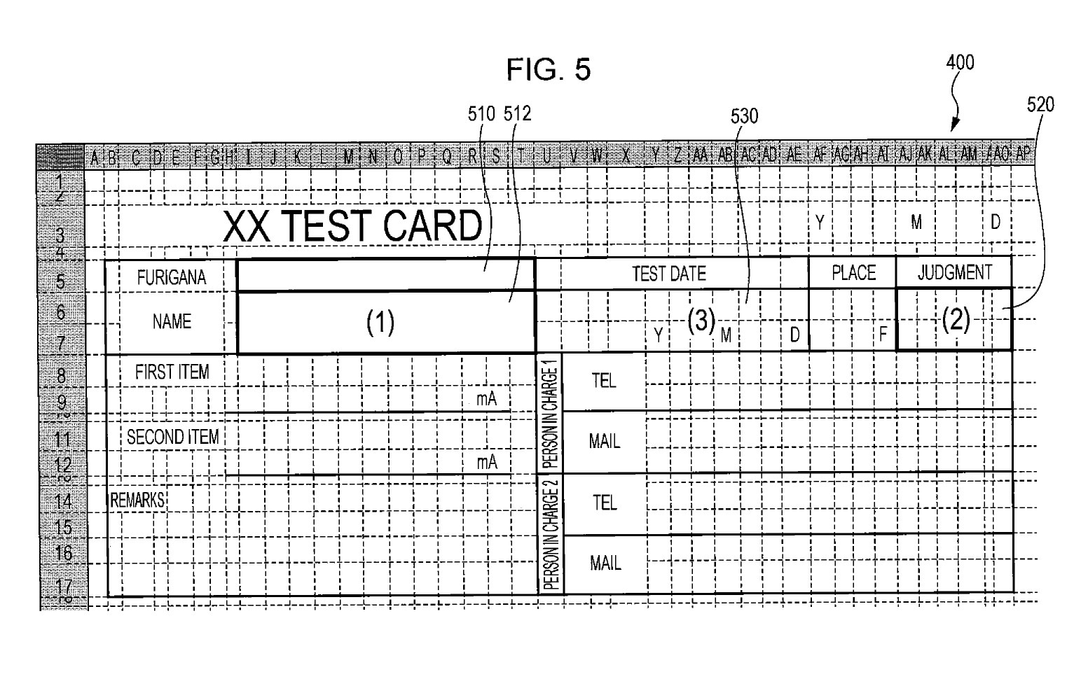

In this case, a cell with a value is not included because, if a cell with a value is included, the layout of the form is changed because the number of values becomes one or the position of a value on the spreadsheet changes at the time of combining, and thus it is desirable not to use a combined cell including such a cell with a value as a target. Here, a region 530 illustrated in FIG. 5 is a cell with a value.

(Condition 3) Scanning is started from a cell which has a ruled line on the lower side and which does not have a value, cells in a detected cell range are combined together, and a combined cell obtained thereby is defined as a data acceptance cell.

An underline is often used for a region of a form in which characters are to be hand-written by a user, and thus a cell which has an underline and which does not have a value is regarded a data acceptance cell. In a case where characters written in a free space or margin of the form are also regarded as data, a cell which has a ruled line on one or more sides, a cell which is adjacent in one cell to a cell having data, or the like may be used as a reference cell.

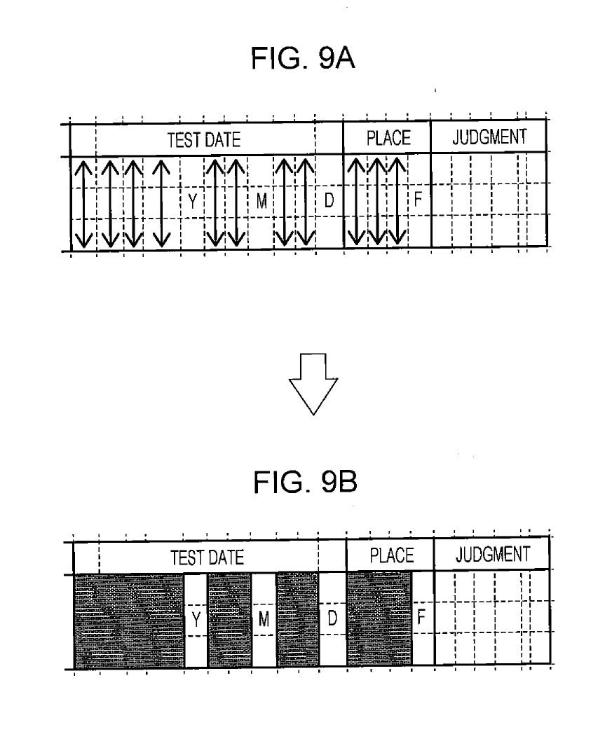

FIG. 5 is an explanatory diagram illustrating an example of a process according to the exemplary embodiment. The spreadsheet 400 includes regions 510, 512, 520, and 530. The regions 510 and 512 are each constituted by one cell. Thus, condition 1 is applied to the regions 510 and 512. The regions 510 and 512 are each defined as a data acceptance cell. The region 520 does not have a value and is surrounded by a ruled line on its four sides. Accordingly, condition 2 is applied to the region 520, and a combined cell obtained by combining the cells in the region 520 is defined as a data acceptance cell. The region 530 includes a cell with a value. Thus, neither condition 1 nor condition 2 is applied to the region 530, but condition 3 is applied to the region 530, as will be described below. Note that the entire region 530 is not defined a data acceptance cell. A data acceptance cell in the region 530 will be described below with reference to FIGS. 9A and 9B.

Now, condition 3 will be described. A target that matches condition 3 is extracted in the following manner.

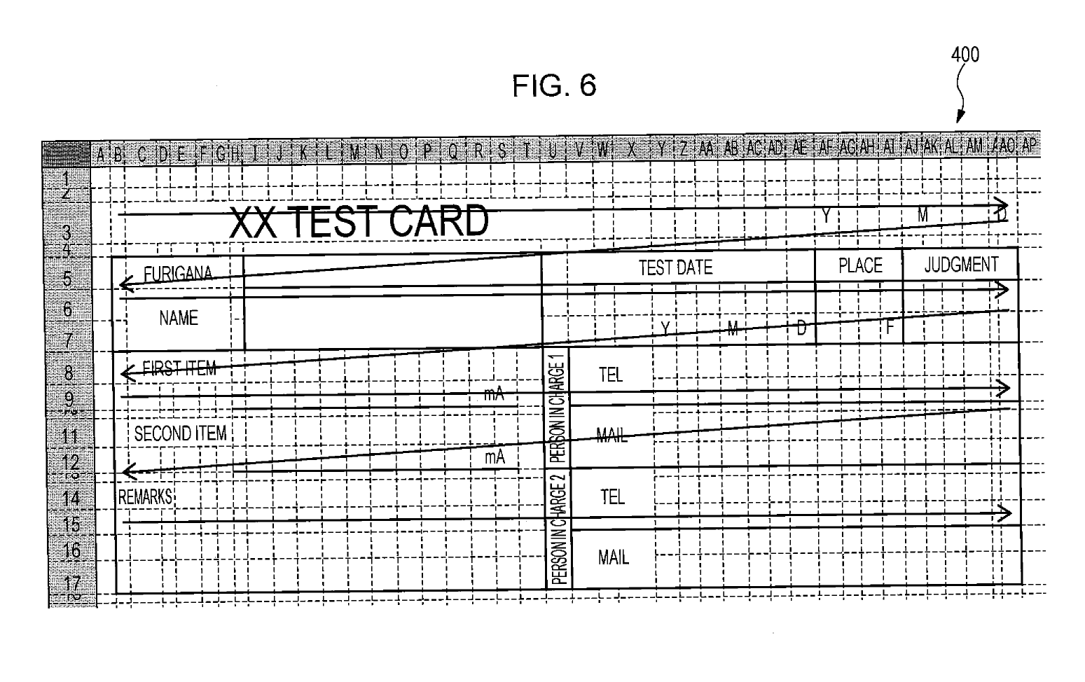

(3-1) As illustrated in FIG. 6, the spreadsheet 400 is scanned in the horizontal direction from the upper left to the lower right (specifically, a first row is scanned in the right direction from the upper left end to the right end, the next row is scanned in the right direction from the left end to the right end, and scanning is repeated in this manner to the lower right end), so as to detect a scanning start cell which has a ruled line on the lower side and which does not have a value.

Because of the structure of a spreadsheet, the direction of flow of data on the spreadsheet is from left to right and from top to bottom (in the case of so-called horizontal writing) in most cases, and thus scanning is performed in the horizontal direction from the upper left to the lower right. However, an exemplary embodiment of the present invention is not limited thereto. For example, in the case of vertical writing, a spreadsheet is scanned in the vertical direction from the upper right to the lower left (specifically, a first row is scanned in the downward direction from the upper right end to the lower end, the next row is scanned in the downward direction from the upper end to the lower end, and scanning is repeated in this manner to the lower left end), so as to detect a scanning start cell which has a ruled line on the left side (or the right side) and which does not have a value.

(3-2) Scanning is performed in the upward direction starting from a scanning start cell until a cell having an attribute different from that of a target cell is detected, and cells in the scanned range are combined together. An attribute of a cell may be, for example, a value in the cell, a ruled line, fill, the numbers of rows/columns to be combined, a formula, a format setting, and so forth. In a case where cells have different attributes, the cells have different meanings, and it is determined that the cells are not in the same range. Scanning is continued in a case where the attribute other than the underline of a scanning start cell is the same. Also, scanning may be continued in a case where the cell is blank.

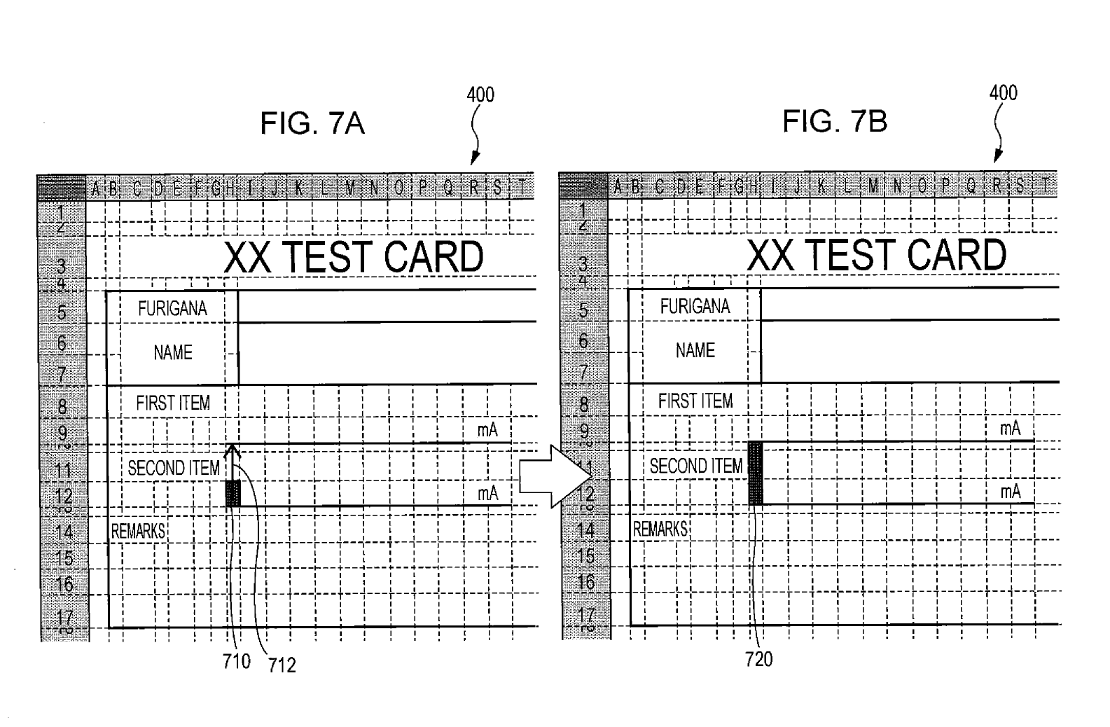

For example, as illustrated in FIG. 7A, a scanning start cell 710 is detected in the process (3-1), an upward-direction scanning 712 is performed in the process (3-2), and thereby a combined cell 720 is generated as illustrated in FIG. 7B. The scanning start cell 710 is a unit cell of “H12” in the spreadsheet 400. The combined cell 720 is obtained by combining three unit cells “H12”, “H11”, and “H10” in the spreadsheet 400.

In the case of vertical writing, scanning may be performed in the right or left direction, not in the upward direction.

(3-3) Scanning is performed in the right direction starting from the combined cell obtained in the process (3-2) until a cell having an attribute different from that of a target cell is detected, and cells in the scanned range are combined together. Here, the meaning of “cells have different attributes” is the same as in the process (3-2).

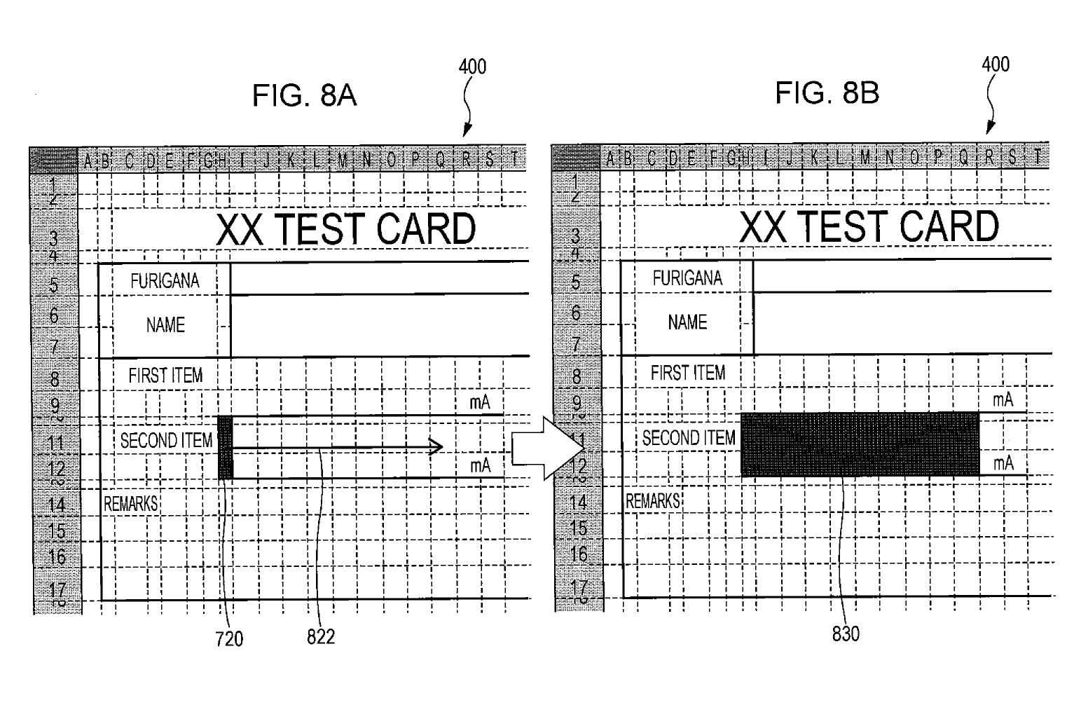

For example, as illustrated in FIG. 8A, the combined cell 720 is generated in the process (3-2), a right-direction scanning 822 is performed, and thereby a combined cell 830 is generated as illustrated in FIG. 8B. Scanning is continued in a case where the individual cells constituting the combined cell 720 have the same attribute before combining. Thus, scanning ends in a case where a cell having a different attribute is detected. Also, scanning may be continued in a case where the cell is blank.

In the case of vertical writing, scanning may be performed in the downward direction, not in the right direction.

(3-4) A combined cell obtained by combining at least two (unit/combined) cells in a cell range is defined as a data acceptance cell.

The reason for combining cells in the vertical direction and then in the horizontal direction as in the processes (3-2) and (3-3) is that, because of the layout of the form for handwriting, a cell range in the vertical direction has a constant height in one data input region in most cases, whereas a cell range in the horizontal direction does not necessarily have a constant height in one data input region in most cases. Thus, the cells are combined in this order.

However, the cells may be combined in the reverse order depending on the layout of the form or specification by the user. For example, in the case of vertical writing, the cells may be combined in the horizontal direction and then in the vertical direction.

In the example illustrated in FIGS. 9A and 9B, cells are combined in the vertical direction (FIG. 9A) and then in the horizontal direction (FIG. 9B).

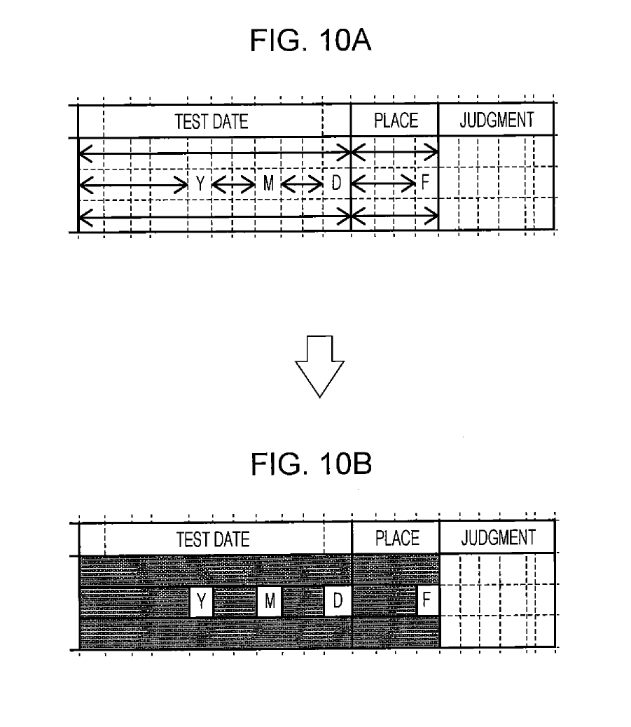

In the example illustrated in FIGS. 10A and 10B, cells are combined in the horizontal direction (FIG. 10A) and then in the vertical direction (FIG. 10B). In this case, a data acceptance cell has a smaller height than in the example illustrated in FIG. 9B. Thus, the example illustrated in FIG. 9B is more suitable for handwritten characters. Therefore, in the case of horizontal writing, cells are combined in the vertical direction and then in the horizontal direction.

(3-5) If necessary, definition of an unnecessary data acceptance cell is deleted.

In a case where a data acceptance cell is defined through the scanning in the processes (3-1) to (3-4), an unnecessary cell may be defined as a data acceptance cell.

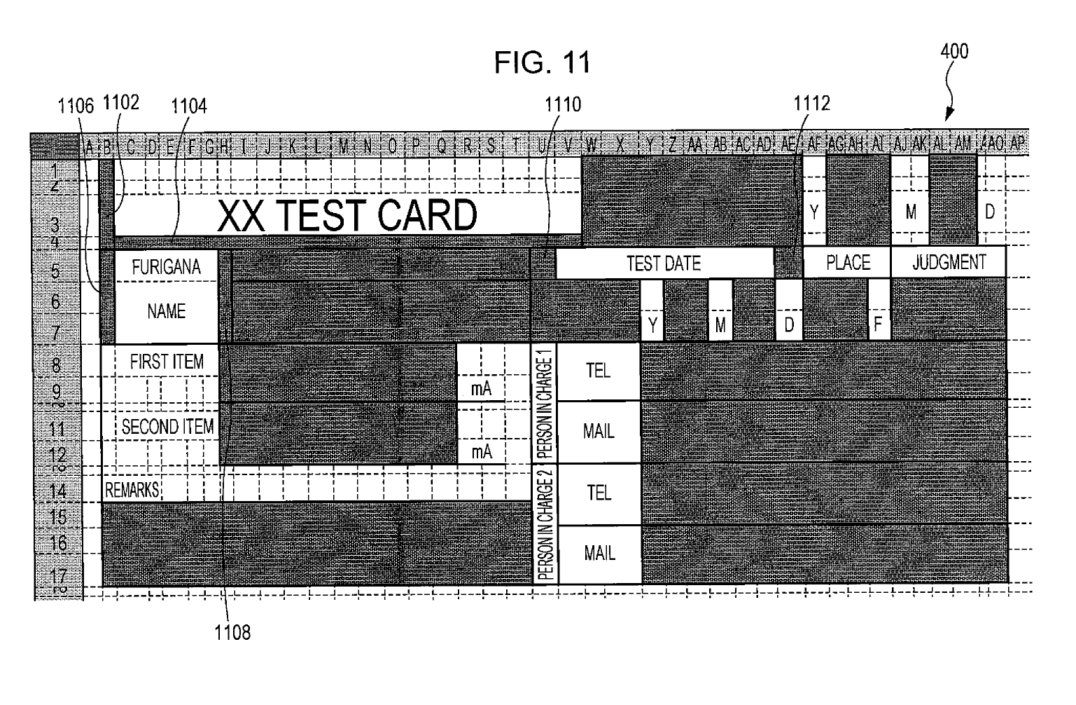

As illustrated in FIG. 11, gray rectangular regions are defined as data acceptance cells in the processes (3-1) to (3-4). Among these data acceptance cells, there are unnecessary cells 1102 to 1112.

It is clear that any characters will not be written in the unnecessary cells 1102 to 1112, and thus there is no inconvenience even if the unnecessary cells 1102 to 1112 are defined as data acceptance cells.

However, the unnecessary cells 1102 to 1112 may be deleted because they are apparently smaller than the other data acceptance cells.

In this case, the cells whose width, height, or size is smaller than or equal to a predetermined threshold are excluded from the data acceptance cells. Further, a data acceptance cell around which there is no free space for writing may be regarded as an unnecessary cell and the definition thereof may be deleted. Before an unnecessary cell is excluded from the data acceptance cells, a warning or the like may be provided for confirmation.

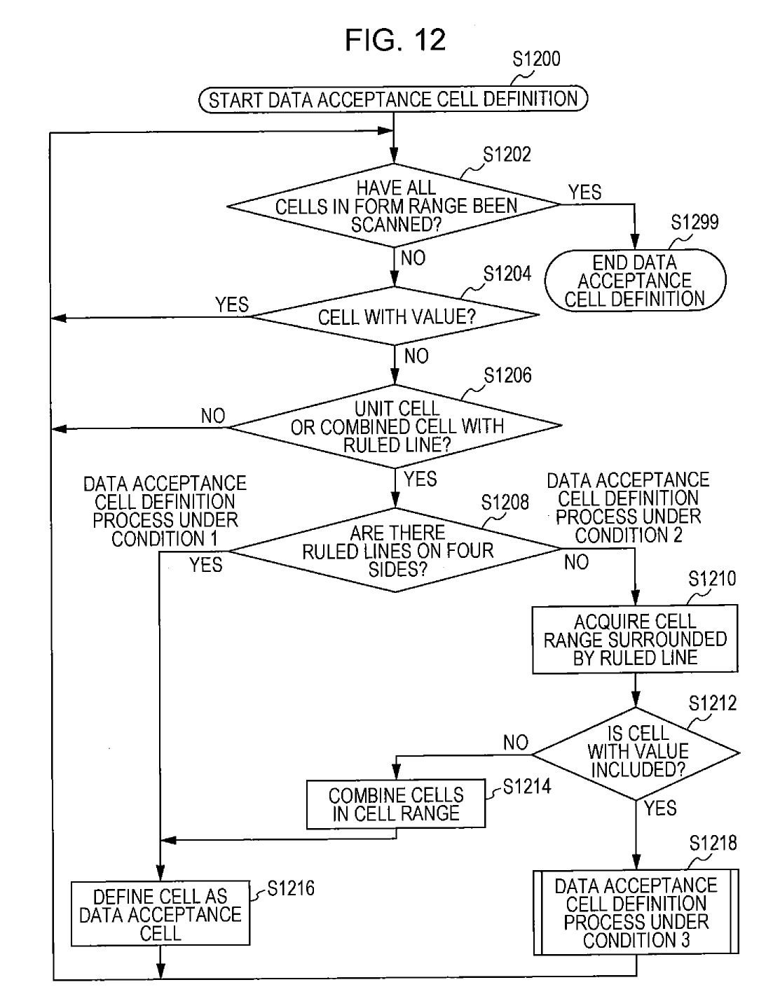

FIG. 12 is a flowchart illustrating an example of a process performed by the definition module 120 according to the exemplary embodiment.

In step S1200, data acceptance cell definition is started.

In step S1202, it is determined whether or not all the cells in a form range as a spreadsheet have been scanned. If all the cells have been scanned, data acceptance cell definition ends (step S1299). Otherwise, the process proceeds to step S1204.

In step S1204, it is determined whether or not a target cell is a cell with a value. If the target cell is a cell with a value, the process returns to step S1202. Otherwise, the process proceeds to step S1206.

In step S1206, it is determined whether or not the target cell is a unit cell or combined cell with a ruled line. If the target cell is a unit cell or combined cell with a ruled line, the process proceeds to step S1208. Otherwise, the process returns to step S1202.

In step S1208, it is determined whether or not the target cell has ruled lines on four sides. If the target cell has ruled lines on four sides, the process proceeds to step S1216 as a data acceptance cell definition process under condition 1. Otherwise, the process proceeds to step S1210 as a data acceptance cell definition process under condition 2.

In step S1210, a cell range surrounded by a ruled line is acquired.

In step S1212, it is determined whether or not the cell range acquired in step S1210 includes a cell with a value. If a cell with a value is included, the process proceeds to step S1218. Otherwise, the process proceeds to step S1214.

In step S1214, the cells in the cell range acquired in step S1210 are combined together.

In step S1216, the cell determined as “YES” in step S1208 or the combined cell acquired in step S1214 is defined as a data acceptance cell.

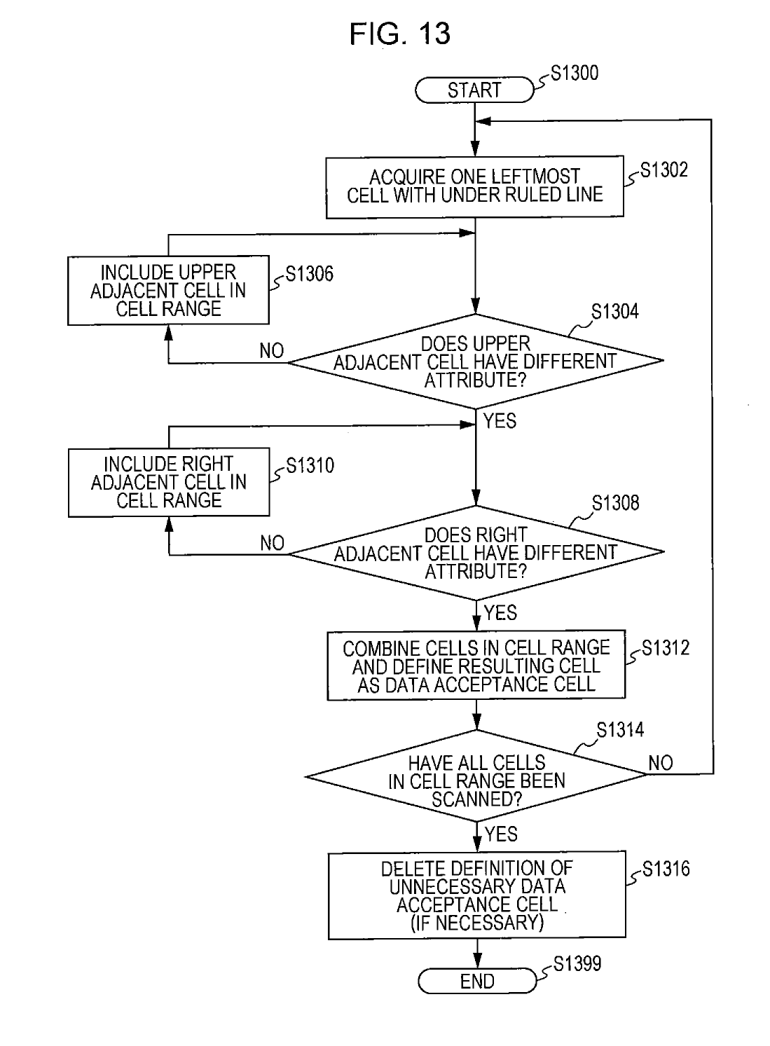

In step S1218, a data acceptance cell definition process is performed under condition 3. The details of step S1218 will be described below with reference to the flowchart in FIG. 13.

FIG. 13 is a flowchart illustrating an example of a process performed by the definition module 120 according to the exemplary embodiment.

In step S1302, a leftmost cell with an under ruled line is acquired from among the cells in the cell range acquired in step S1210. Alternatively, a leftmost cell with an under ruled line and with no value may be acquired from among the cells in the cell range acquired in step S1210.

In step S1304, it is determined whether or not an upper adjacent cell of a target cell has a different attribute. If the upper adjacent cell has a different attribute, the process proceeds to step S1308. Otherwise (if the upper adjacent cell has the same attribute), the process proceeds to step S1306.

In step S1306, the upper adjacent cell is included in the cell range.

In step S1308, it is determined whether or not a right adjacent cell of the target cell has a different attribute. If the right adjacent cell has a different attribute, the process proceeds to step S1312. Otherwise (if the right adjacent cell has the same attribute), the process proceeds to step S1310.

In step S1310, the right adjacent cell is included in the cell range.

In step S1312, the cells in the cell range are combined together, and the combined cell obtained thereby is defined as a data acceptance cell.

In step S1314, it is determined whether or not all the cells in the cell range acquired in step 1210 have been scanned. If all the cells have been scanned, the process proceeds to step S1316. Otherwise, the process returns to step S1302.

In step S1316, definition of an unnecessary data acceptance cell is deleted if necessary. This process may be performed after it is determined as “YES” in step S1202 in the flowchart illustrated in FIG. 12.

The definition module 120 may define a data acceptance cell using the following conditions.

(Condition 4) A data acceptance cell is defined using other information set to a cell.

For example, in a case where the following setting is performed in cells, a cell range including the cells may be defined as a data acceptance cell.
One cell range constituted by cells with no data is filled with the same color.
One cell range constituted by cells with no data has the same pattern (for example, shaded).
One cell with no data is referred to as a calculation target, a macro process target, a link source, or the like.
One cell with no data has specification information, such as a name or ID, set thereto.

(Condition 5) A cell range specified by a user is defined as a data acceptance cell.

A cell range satisfying the condition specified by the user is defined as a data acceptance cell. For example, the user may manually specify a data acceptance cell range. For example, the user may set a condition of a cell having predetermined data.

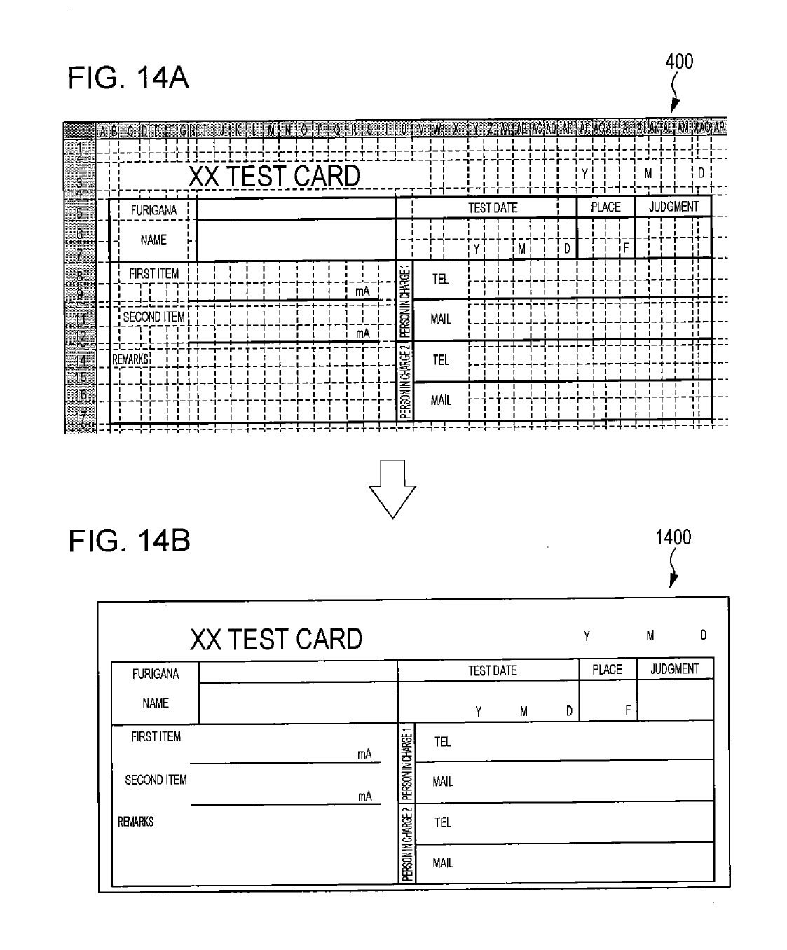

Next, the format creation module 130 will be described. The format creation module 130 creates a form format in which the positions of character acceptance frames are defined, by using a spreadsheet accepted by the spreadsheet acceptance module 110. For example, as illustrated in FIGS. 14A and 14B, the format creation module 130 creates a form format 1400 by using the spreadsheet 400.

The form format is a general definition for performing processing of handwritten data. For example, a character acceptance frame is regarded as a character recognition region, and a character recognition condition (language, dictionary, character type, etc.) is defined.

The process of performing such a definition is as follows, for example.
Definition is made using information (position, size, format, etc.) about a data acceptance cell defined on the spreadsheet 400. Here, “format” is an attribute that is set for a cell in the spreadsheet. The format includes “numerical value”, “date”, and so forth, and a character recognition condition may be defined. For example, in a case where the format is “numerical value”, a recognition process is performed using a dictionary of “numeral” (a sign “—” or the like may be included), so as to increase a recognition rate.
Definition is made using elements (ruled lines, characters, etc.) on a form image.
Definition is made using a general method (existing method) for creating the form format 1400 from electronic data.

Of course, the form format 1400 may be created by using plural methods in combination.

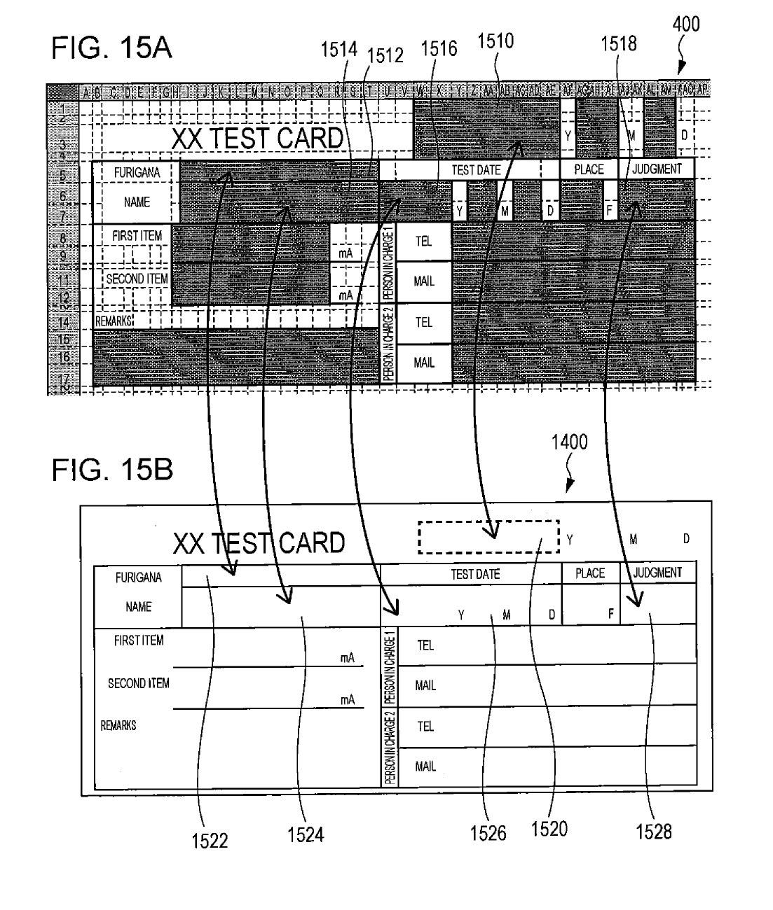

On the other hand, the association module 140 associates a data acceptance cell defined by the definition module 120 with a character recognition region (character acceptance frame) in the form format created by the format creation module 130. As illustrated in FIGS. 15A and 15B, the association module 140 associates data acceptance cells defined on the spreadsheet 400 with character recognition regions defined on the form format 1400. Specifically, the association module 140 associates a combined cell 1510 of the spreadsheet 400 with a region 1520 of the form format 1400, a combined cell 1512 with a region 1522, a combined cell 1514 with a region 1524, a combined cell 1516 with a region 1526, and a combined cell 1518 with a region 1528.

Also, the association module 140 generates a correspondence table 1600 as a result of performing association. FIG. 16 is an explanatory diagram illustrating an example of the data structure of the correspondence table 1600. The correspondence table 1600 includes a data acceptance cell column 1610 and a character recognition region column 1620. The data acceptance cell column 1610 stores data acceptance cells (for example, cell ranges indicated by column numbers and row numbers, in this example, two numbers indicating the upper left and the lower right of each region are used). The character recognition region column 1620 stores character recognition regions corresponding to individual data acceptance cells (for example, the coordinates of the upper left and the lower right of each rectangular region, not illustrated). The correspondence table 1600 is used to reflect (write back) the character recognition result in the character recognition region column 1620 in the corresponding data acceptance cell column 1610.

The association process is performed in the following manner, for example.
In a case where character recognition regions on the form format 1400 are defined using data acceptance cells defined on the spreadsheet 400, both are associated with each other in accordance with the order in which they are defined, relative positional relationships, an item set to the cells, and so forth.
Both are associated with each other in accordance with elements on the format layout (positional relationship, ruled lines, characters, and so forth).

Of course, both may be associated with each other using plural methods in combination.

The output module 150 outputs the form format 1400 that is to be used for performing handwritten data processing by the information processing apparatus 200 illustrated in FIG. 2.

The following are included as the form format 1400.
A general definition for performing handwritten data processing (see the above description of the process of the format creation module 130)
The correspondence between data acceptance cells and character recognition regions (specifically, the correspondence table 1600 illustrated in FIG. 16)
A spreadsheet in which handwritten data is reflected (data or a destination that is referred to)

A data container containing all of the above-described pieces of data may be used as a form format. Alternatively, the pieces of data may be collectively or separately registered in a table in a database.

The form, storage manner, storage site, and so forth of the “form format” are not specified as long as necessary information is available when it is necessary.

The format acquisition module 210 acquires a form format corresponding to a form (paper) on which characters have been written by hand.

The process of acquiring a form format is performed in the following manner.
A corresponding form format is extracted by performing a matching process between a scanned image of a handwritten form (paper) and a form format.
Identification information that is optically or magnetically given (information identifying a form format, identification (ID)) is read from a handwritten form (paper), so as to specify a form format.
A general method (existing method) for acquiring a form format of a handwritten form (paper) may be used.

Of course, a form format may be acquired using plural methods in combination.

The character recognition data acquisition module 220 acquires character recognition data for characters written on the form by hand (character image, stroke information).

The process of acquiring character recognition data is performed in the following manner. The process is performed for each character recognition region.
A handwritten form (paper) is scanned, and character recognition is performed on a difference between the scanned image and a form format.
Character recognition is performed using a device, such as an electronic pen, for acquiring stroke information of handwriting performed on a form (paper).
A general method (existing method) for recognizing characters written on paper by hand may be used.

Of course, character recognition data may be acquired using plural methods in combination.

The reflection module 230 reflects acquired recognition result data in a data acceptance cell on a spreadsheet. The reflection is performed in the following manner, for example.

A spreadsheet, in which recognition result data held in a form format is to be reflected, is acquired.

Then, the recognition result data is embedded in a data acceptance cell on the spreadsheet corresponding to a character recognition region held in the form format.

In the exemplary embodiment, handwritten character recognition data is accepted as cell data for a spreadsheet.

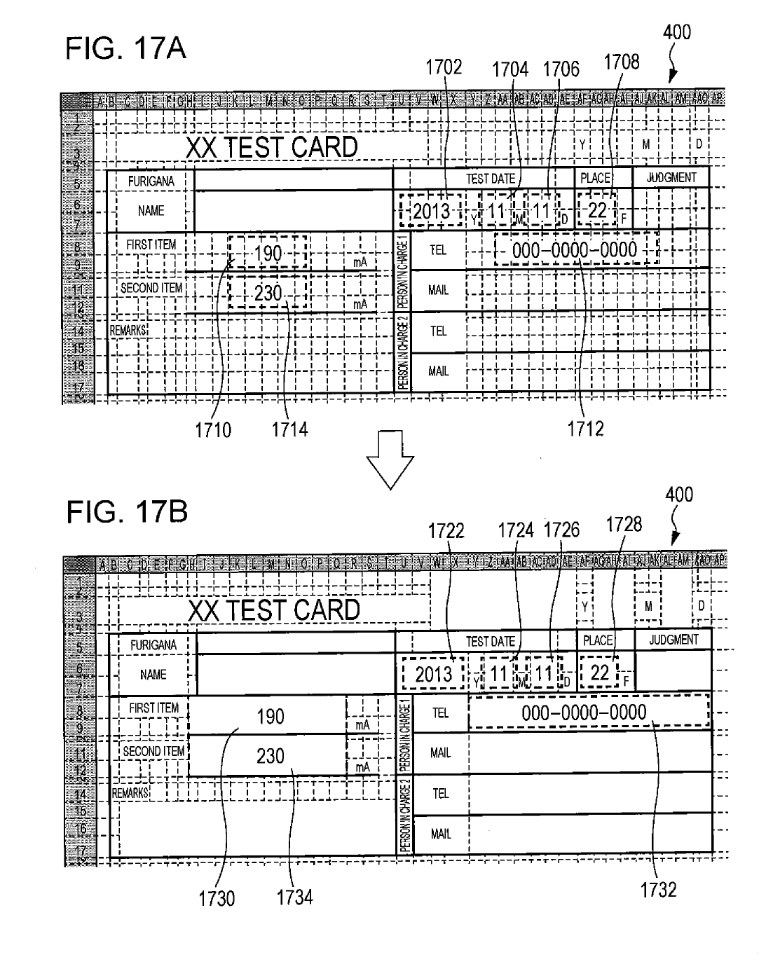

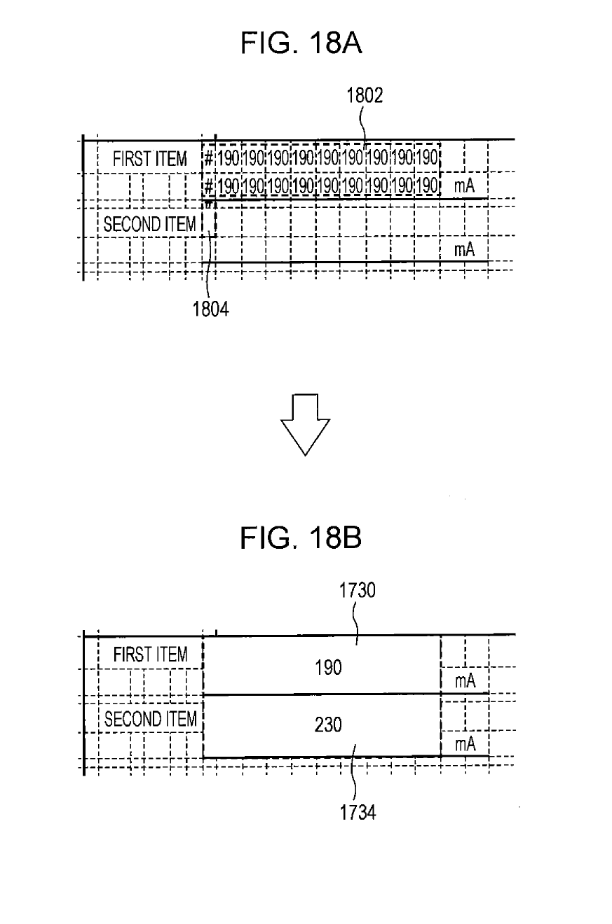

FIGS. 17A and 18A illustrate an example of a result in a case where the exemplary embodiment is not used. FIGS. 17B and 18B illustrate an example of a result in a case where the exemplary embodiment is used.

Regions 1702 to 1714 illustrated in FIG. 17A do not correspond to cells in the spreadsheet 400, and are placed simply as text frames. This is a case where the exemplary embodiment is not used, and text frames are placed at the positions of characters written on the form (paper). FIG. 17A illustrates a case where handwritten character recognition data is placed at original positions. Although an original electronic document is a spreadsheet, character recognition data is not reflected in the cells.

The example illustrated in FIG. 17B is implemented based on the exemplary embodiment, and character recognition data is reflected in the cells in the spreadsheet 400. The character recognition data is reflected in individual data acceptance cells 1722 to 1734.

In a region 1802 illustrated in FIG. 18A, handwritten character recognition data is input to a cell group corresponding to the positions of characters written on the form (paper), and the same handwritten character recognition data is embedded in plural cells. In a region 1804, handwritten character recognition data is input to a predetermined cell (for example, the upper left cell) corresponding to the position of a character written on the form (paper). That is, in a case where the exemplary embodiment is not used and where the correspondence on the original spreadsheet is “a range (plural cells)”, data accepted in the range is different from data intended for handwriting. In a case where handwritten character recognition data is input to a specific cell in the range, for example, the head cell in the range, the position where characters are hand-written becomes different from the position of a data acceptance cell.

The example illustrated in FIG. 18B is implemented based on the exemplary embodiment, in which character recognition data is reflected in data acceptance cells 1730 and 1734 in the spreadsheet 400. The data acceptance cells 1730 and 1734 are combined cells, and thus one piece of character recognition data is reflected at each handwritten position.

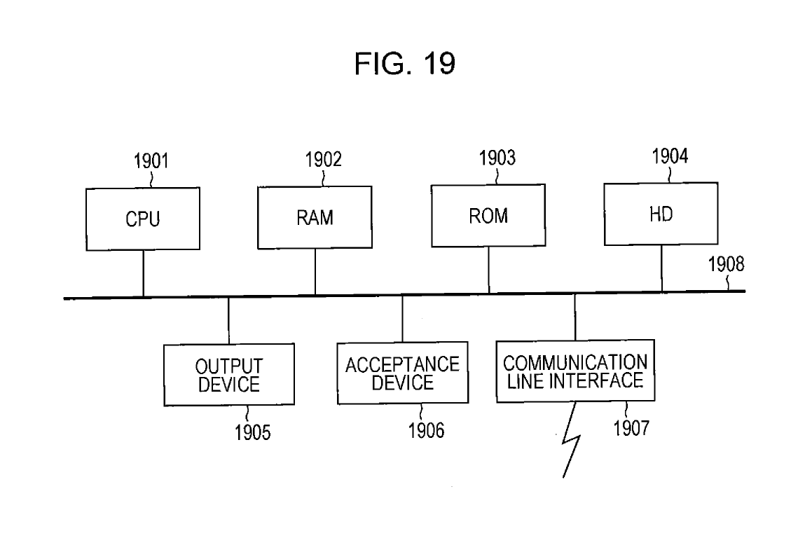

A computer that executes a program according to the exemplary embodiment is a typical computer, specifically, a personal computer or a computer serving as a server. The hardware configuration of such a computer is illustrated in FIG. 19. As a specific example, a central processing unit (CPU) 1901 is used as a processing unit (operation unit), and a random access memory (RAM) 1902, a read only memory (ROM) 1903, and a hard disk (HD) 1904 are used as a storage device. The CPU 1901 executes a program for the spreadsheet acceptance module 110, the definition module 120, the format creation module 130, the association module 140, the output module 150, the format acquisition module 210, the character recognition data acquisition module 220, the reflection module 230, and so forth. The RAM 1902 stores the program and data. The ROM 1903 stores a program for starting the computer. The HD 1904 servers as an auxiliary storage device (or a flash memory or the like). An acceptance device 1906 accepts data in accordance with a user operation performed on a keyboard, a mouse, a touch panel, or the like. An output device 1905 is constituted by a cathode ray tube (CRT), a liquid crystal display, or the like. A communication line interface 1907, such as a network interface card, is used to connect to a communication network. A bus 1908 connects these devices so that data is transmitted and received among them. Plural computers, each being the computer described above, may be connected to one another via a network.

Regarding a part implemented by a computer program in the above-described embodiment, the computer program as software is installed into a system having the above-described hardware configuration, and the software and hardware resources cooperate with each other to realize the above-described embodiment.

The hardware configuration illustrated in FIG. 19 is merely an example. The hardware configuration of the exemplary embodiment is not limited to the one illustrated in FIG. 19, and any configuration may be adopted as long as the modules described in the exemplary embodiment are implementable. For example, some of the modules may be constituted by dedicated hardware (for example, an application specific integrated circuit (ASIC)), some of the modules may be in an external system and connected via a communication line, or plural systems, each being the system illustrated in FIG. 19, may be connected to one another via a communication line so as to operate in conjunction with another. In particular, the modules may be incorporated in an information appliance, a copier, a facsimile machine, a scanner, a printer, or a multifunction peripheral (an image processing apparatus having two or more of a scanner function, a printer function, a copier function, a facsimile function, and so forth), instead of the personal computer.

The above-described program may be provided by being stored in a recording medium, or may be provided via a communication medium. In this case, for example, the above-described program may be regarded as a “computer readable recording medium that stores the program”.

The “computer readable recording medium that stores the program” is a computer readable recording medium that stores the program and that is used to install, execute, or circulate the program.

Examples of the recording medium include a digital versatile disc (DVD), for example, the standards defined by the DVD forum: DVD-R, DVD-RW, DVD-RAM, and so forth, and the standards defined by DVD+RW: DVD+R, DVD+RW, and so forth; a compact disc (CD), for example, a read only memory (CD-ROM), a CD recordable (CD-R), a CD rewritable (CD-RW), and so forth; a Blu-ray (registered trademark) Disc; a magneto-optical (MO) disc; a flexible disk (FD); a magnetic tape; a hard disk; a read only memory (ROM); an electrically erasable and programmable ROM (EEPROM, registered trademark); a flash memory; a random access memory (RAM); and a secure digital (SD) memory card.

The above-described program or part of the program may be stored or circulated by recorded it on the recording medium. Alternatively, the program or part of the program may be transmitted through communication, for example, using a wired network such as a local area network (LAN), a metropolitan network (MAN), a wide area network (WAN), the Internet, an intranet, or an extranet, or a wireless communication network, or a transmission medium that is obtained by combining the wired and wireless networks. Alternatively, the program or part of the program may be carried using carrier waves.

Further, the above-described program may be part of another program, or may be recorded on a recording medium together with another program. Alternatively, the program may be recorded on plural recording media in a distributed manner. The manner in which the program is recorded is not specified as long as the program is able to be compressed, encrypted, or restored.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a detection unit that detects a character acceptance frame from a spreadsheet having the character acceptance frame;
a combining unit that combines cells in the spreadsheet into a combined cell, the cells corresponding to the character acceptance frame detected by the detection unit; and
a definition unit that defines the combined cell generated by the combining unit as one cell that accepts a character string to be written in the character acceptance frame.

2. The information processing apparatus according to claim 1, further comprising:
a creation unit that creates, using the spreadsheet, a format of a document in which a position of the character acceptance frame is defined; and
an association unit that associates the cell defined by the definition unit with the character acceptance frame in the format of the document.

3. The information processing apparatus according to claim 2, the character acceptance frame in the format of the document being an input region in which handwriting is to be performed, the information processing apparatus further comprising:
an acceptance unit that accepts a recognition result of a character string written in the character accepting frame; and
a reflection unit that reflects the recognition result in the cell associated with the character acceptance frame in the format of the document.

4. The information processing apparatus according to claim 1, wherein the definition unit excludes the combined cell generated by the combining unit in a case where the combined cell has a width, height, or size that is smaller than or equal to a predetermined threshold.

5. The information processing apparatus according to claim 2, wherein the definition unit excludes the combined cell generated by the combining unit in a case where the combined cell has a width, height, or size that is smaller than or equal to a predetermined threshold.

6. The information processing apparatus according to claim 3, wherein the definition unit excludes the combined cell generated by the combining unit in a case where the combined cell has a width, height, or size that is smaller than or equal to a predetermined threshold.

7. A non-transitory computer readable medium storing a program causing a computer to execute a process, the process comprising:
detecting a character acceptance frame from a spreadsheet having the character acceptance frame;
combining cells in the spreadsheet into a combined cell, the cells corresponding to the detected character acceptance frame; and
defining the combined cell as one cell that accepts a character string to be written in the character acceptance frame.

8. An information processing apparatus comprising:
a detection unit that detects a character acceptance frame from a spreadsheet having the character acceptance frame, in accordance with a change in attribute of sequential cells; and
a definition unit that defines the character acceptance frame detected by the detection unit as a data acceptance cell that accepts character information.
